(19) United States
(12) Patent Application Publication
(10) Pub. No.: US 2018/0124562 A1
(43) Pub. Date: May 3, 2018

(54) VIRTUAL PERIMETER SYSTEM AND METHOD

(71) Applicant: LONE WORKER SOLUTIONS LTD., Rochdale (GB)

(72) Inventor: Stephen White, Bury (GB)

(73) Assignee: LONE WORKER SOLUTIONS LTD., Bury (GB)

(21) Appl. No.: 15/553,357

(22) PCT Filed: Feb. 25, 2016
(86) PCT No.: PCT/GB2016/050474

§ 371 Date: Aug. 24, 2017

(30) Foreign Application Priority Data
Feb. 25, 2015 (GB) 1503143.8

(51) Int. Cl. H04W 4/021; H04W 4/02; H04W 68/00

(52) U.S. Cl. CPC H04W 4/021; H04W 68/005; H04W 4/028

(57) ABSTRACT

A virtual perimeter system for determining a position of a mobile device relative to a virtual perimeter, comprises: a plurality of transmitters configured to broadcast a unique identifier; a management platform for storing positional data for each transmitter; and a mobile application for installation on a mobile device. The management platform is configured to communicate with the mobile application. The transmitters are positioned to define the virtual perimeter around a target entity. The management platform is configured to: (a) map the perimeter dependent upon the positional data; (b) receive transmitted data from the mobile application when it detects the unique identifier the transmitters and determine a proximate location of the mobile device; and (c) send an alert to the mobile application for display on said mobile device. The perimeter comprises a perimeter profile stored on the management platform comprising target entity information having a mobility status of the entity.

### BACKGROUND

### Technical Field

The present invention relates generally to the field of security and health and safety systems. More particularly, but not exclusively, the present invention concerns a virtual perimeter system for use in a security and/or health and safety context.

### SUMMARY OF THE INVENTION

In a first aspect of the present invention there is provided a virtual perimeter system for determining a position of a mobile device relative to a virtual perimeter, comprising: a plurality of transmitters each configured to broadcast a unique identifier; a management platform for storing positional data for each transmitter; and a mobile application for installation on a mobile device, the management platform being configured to communicate with the mobile application, the plurality of transmitters being positioned so as to define the virtual perimeter around a target entity, and the management platform is configured to: (a) map the perimeter defined by said transmitters dependent upon the positional data stored; (b) receive transmitted data from the mobile application when the mobile application detects the unique identifier of one or more of the transmitters and thereby determine a proximate location of the mobile device relative to the perimeter; and (c) send an alert to the mobile application for display on said mobile device depending upon said proximate location, characterised in that the perimeter comprises a perimeter profile stored on the management platform comprising target entity information, e.g. information regarding a type of entity, and the target entity information comprises a mobility status of the entity, e.g. stationary or mobile/moving, such as a building or a vehicle/carriage respectively.

With this system, a user of a mobile phone can be informed of their approach/crossing of a virtual perimeter without the system having to rely on GPS data. In addition, the system is mobile since the perimeter defined by the transmitters does not need to remain in one place and the perimeter can therefore, be deployed around a moving entity. The system is efficient and inexpensive to employ since the transmitters do not need to employ two-way communication, since they simply broadcast a universally unique identifier (UUI), which is picked up by a mobile device running the appropriate mobile application: the positional data is stored and mapped by a remote server and the system only requires internet connectivity for a mobile device hosting the application and the management platform.

Preferably, the virtual perimeter comprises a wireless perimeter.

Preferably, therefore, the transmitters comprise wireless technology configured to exchange data over short distances. More preferably, the transmitters comprise Bluetooth® technology. Most preferably, the transmitters comprise Bluetooth® Low Energy (BLE) technology.

The transmitters may comprise iBeacon® technology provided by Apple, Inc.

Preferably, the unique identifiers comprise universally unique identifiers, e.g. an identifier that is unique amongst all transmitters used worldwide.

Preferably, the positional data comprises a transmitter position within the perimeter, e.g. relative to the other transmitters in the perimeter. Preferably, therefore, the positional data comprises a sequentially appointed number for each transmitter within the perimeter.

Preferably, the perimeter profile comprises the UUI and the positional data for each transmitter. Preferably, the management platform comprises at least one perimeter profile.

Preferably, each perimeter profile comprises a perimeter identifier, e.g. information regarding the geographical location of the perimeter.

Preferably, each perimeter profile comprises an entity name, e.g. Substation' or ‘Hazardous Waste Train’.

Preferably, each perimeter profile comprises: one or more alert messages and/or one or more alert procedures and/or one or more alert conditions.

Preferably, the management platform comprises a perimeter module comprising one or more of said perimeter profiles.

Preferably, the proximate location of the mobile device is determined using said transmitted data.

Preferably, the transmitted data comprises at least the UUI of at least one transmitter. Preferably, the transmitted data comprises an approximate distance of the mobile device from at least one transmitter. Preferably, the transmitted data comprises a unique user personal identifier.

Preferably, the management platform comprises individual user profiles for each user. Preferably, each user profile comprises the user personal identifier. Preferably, each user profile comprises personal data regarding the respective user. Preferably, each user profile comprises user permissions for the respective user. Preferably, each user profile comprises a user location history for the respective user. Preferably, the user permissions for a user are set for each perimeter profile.

Preferably, the management platform comprises a user module comprising one or more of said user profiles. Preferably, the user module is configured to receive proximity location data from the perimeter profile module and store it in the location history for the user.

Preferably, the user personal identifier is stored by the mobile application on a user's mobile device.

Preferably, the management platform is configured to receive transmitted data and transmit alerts over the internet to and from the mobile application.

Preferably, each perimeter profile comprises at least one ‘approach’ alert message. Preferably, the approach alert message conveys a message notifying of the presence of a perimeter in the vicinity.

Preferably, each perimeter profile comprises at least one ‘warning alert message. Preferably, the warning alert message conveys a message notifying that a user has passed beyond a boundary of the perimeter. Additionally, or alternatively, the warning alert message provides information about a user's security clearance status. Additionally, or alternatively, the warning alert message provides information about special conditions that must be observed within a respective perimeter (e.g. safety clothing).

Preferably, each perimeter profile comprises at least one alert procedure. Preferably, the alert procedure raises an alarm to trigger a particular escalation procedure for the respective user, e.g. notifying third parties of a particular user passing within a perimeter. The alert procedure may sound an audible alarm within the vicinity of the target entity.

Preferably, each perimeter profile comprises at least one alert condition. Each alert condition may be fulfilled when a proximity location of a mobile device is determined as being within a particular distance range of the perimeter. There may be a plurality of ranges. The ranges may include an immediate range and/or a near range and/or a far range.

The immediate range may comprise a distance of up to approximately 1 metre of transmitter, more preferably, up to approximately 0.5 metre of a transmitter, most preferably, up to a few centimetres of a transmitter.

The near range may comprise a distance of up to approximately 3 metres of transmitter, more preferably, up to approximately 2 metres of a transmitter, most preferably, up to 1 metre of a transmitter.

The far range may comprise a distance of up to approximately 50 metres of transmitter, more preferably, up to approximately 25 metres of a transmitter, most preferably, up to 10 metres of a transmitter.

Preferably, the perimeter module is configured to receive the transmitted data from the mobile application.

Preferably, the perimeter module is configured to identify respective perimeter profile by cross-referencing the received UUIs with the stored UUIs of each perimeter profile.

Preferably, the perimeter module is configured to identify a respective user and store the proximity location within the user's profile in said user module.

Preferably, the perimeter module is configured to select an appropriate alert to said mobile application by cross-referencing the alerts in the perimeter profile with the user's permissions in the user profile. Preferably, the selection of the alert also cross-references the approximate distance of the mobile device from at least one transmitter

Preferably, the mobile application comprises a wireless detection protocol to identify broadcasted UUIs for transmitters. Preferably, the mobile application is configured to approximately find its relative location to at least one transmitter.

Preferably, the mobile application comprises a wireless data transmission protocol to transmit data across the internet.

Preferably, the mobile application comprises a data receiving protocol to receive alerts.

Preferably, the mobile application comprises a mobile user interface to display/execute received data.

Preferably, the mobile application is configured to store a user's personal identifier.

Preferably, the mobile application is configured to store one or more perimeter profiles.

Preferably, the transmitters are configured to be deployed around target entities, by fixing or adhesion means.

In a second aspect of the present invention there is provided a method for establishing a virtual perimeter for determining a position of a mobile device relative to a target entity, comprising: deploying a plurality of transmitters each configured to broadcast a unique identifier; configuring a management platform to store positional data for each transmitter; and installing a mobile application on a mobile device, configuring the management platform to communicate with the mobile application, the method comprising deploying the plurality of transmitters around a target entity, and further configuring the management platform to: (a) map the perimeter defined by said transmitters dependent upon the positional data stored; (b) receive transmitted data from the mobile application when the mobile application detects the unique identifier of one or more of the transmitters and thereby determine a proximate location of the mobile device relative to the perimeter; and (c) send an alert to the mobile application for display on said mobile device depending upon said proximate location, characterised in that the method comprises creating a perimeter profile and storing it on the management platform comprising target entity information, e.g. information regarding a type of entity, and providing the target entity information with a mobility status of the entity, e.g. stationary or mobile/moving, such as a building or a vehicle/carriage respectively.

It will be appreciated that the preferred features described in relation to the first aspect of the invention apply to the second aspect of the invention.

### BRIEF DESCRIPTION OF THE DRAWINGS

For a better understanding of the invention, and to show how exemplary embodiments may be carried into effect, reference will now be made to the accompanying drawings in which:

FIG. 1 shows an application of a virtual perimeter system according to one embodiment of the invention;

FIG. 2 shows an application of the virtual perimeter system according to FIG. 1 in use;

FIG. 3A is a flowchart demonstrating the method of set-up of the invention;

FIG. 3B is a flowchart demonstrating the method of use of the invention;

FIG. 4 shows an application of a virtual perimeter system according to another embodiment of the invention; and

FIG. 5 shows an application of the virtual perimeter system according to FIG. 2 in use.

### DETAILED DESCRIPTION OF THE EXEMPLARY EMBODIMENTS

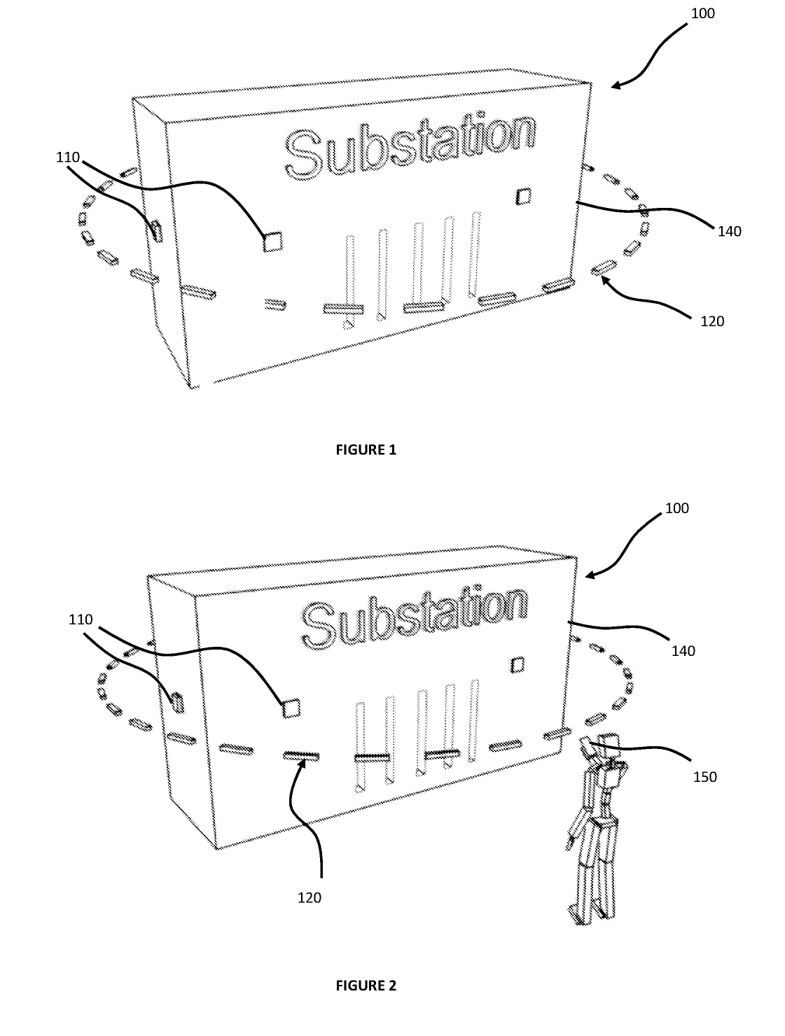

The FIGS. 1-5 show a virtual perimeter system 100, 200 according to an exemplary embodiment of the invention.

As shown in the Figures, a virtual perimeter system 100, 200 for determining a position of a mobile device 150, 250 relative to virtual perimeter comprises: a plurality of transmitters 110, 210 each configured to broadcast a unique identifier; a management platform (not shown) for storing positional data for each transmitter 110, 210; and a mobile application (not shown) for installation on a mobile device 150, 250, the management platform being configured to communicate with the mobile application, the plurality of transmitters 110, 210 being positioned so as to define the virtual perimeter 120, 220 around a target entity 140, 240, and the management platform is configured to: (a) map the perimeter 120, 220 defined by said transmitters 110, 210 dependent upon the positional data stored; (b) receive transmitted data from the mobile application when the mobile application detects the unique identifier of one or more of the transmitters 110, 210 and thereby determine a proximate location of the mobile device 150, 250 relative to the perimeter 120, 220; and (c) send an alert to the mobile application for display on said mobile device 150, 250 depending upon said proximate location, characterised in that the perimeter 120, 220 comprises a perimeter profile stored on the management platform comprising target entity information, e.g. information regarding a type of entity, and the target entity information comprises a mobility status of the entity, e.g. stationary or mobile/moving, such as a building or a vehicle/carriage respectively.

The transmitters 110, 210 employ wireless technology configured to exchange data over short distances. In preferred embodiments, the transmitters 110, 210 employ Bluetooth® and in exemplary embodiments, the transmitters 110, 210 employ Bluetooth® Low Energy (BLE) technology. Suitably configured transmitters 110, 210 include the iBeacon® that is provided by Apple, Inc.

The management platform is configured to transmit and receive data over the internet to the mobile application.

The management platform comprises a perimeter module adapted to create and store perimeter profiles for a specific perimeter 120, 220.

Each perimeter profile comprises: (1) a perimeter identifier; (2) data about the perimeter location, such as the target entity whether stationary or mobile (e.g. ‘Substation’ 100 or ‘Hazardous Waste Train’ 200); (3) transmitter data for each transmitter 110, 210 associated with the perimeter 120, 220, including a transmitter identifier, a respective UUI and the transmitter position relative to the other transmitters 110, 210; and (4) one or more alert messages and/or alert procedures and/or alert conditions.

There may be more than one alert message, alert procedure or alert condition for each profile depending upon the purpose of the perimeter 120, 220.

For example, an ‘approach’ alert message conveys a message notifying of the presence of a perimeter 120, 220 in the vicinity, whereas a ‘warning’ alert message conveys a message notifying that a user has passed beyond the boundary of the perimeter 120, 220 and/or provides information about a user's security clearance status, and/or provides information about special conditions that must be observed within that perimeter 120, 220 (e.g. safety clothing).

An alert procedure may raise an alarm to trigger a particular escalation procedure for a particular user, for example, notifying third parties of a particular user passing within a perimeter, or sounding an audible alarm within the vicinity of the target entity 140, 240.

Accordingly, alert conditions, may include a proximity location being within a particular distance range of the perimeter 120, 220. In this respect, the user can be informed of the correct safety procedure or warned that they do not have the authorisation to enter that area. If an unauthorised user enters the perimeter 120, 220, the warning alert may receive an audible warning or alarm through the mobile device 150, 250 and/or the system may raise an alarm to trigger a particular escalation procedure for the particular user.

The perimeter module is configured to: (1) receive transmitted data from the mobile application regarding the user's personal identifier, transmitter UUIs and distance of the mobile 150, 250 from the transmitters 110, 210; (2) cross-reference the UUI's with the UUIs stored within each perimeter profile and identify an respective perimeter profile; (3) access the user profile associated with the user's personal identifier and store the proximity location within the user's profile; (4) cross-reference the user's permissions for the respective perimeter profile; (5) select an alert from the stored alerts depending upon the user's permissions for the perimeter and the distance of the mobile 150, 250 from the detected transmitters 110, 210; and (6) transmit the alert to the mobile application of the user's mobile device 150, 250.

In order to assist the selection of an appropriate alert, the distance of the mobile 150, 250 from the detected transmitters 110, 210 is categorised into one of three predetermined ranges:
Immediate, e.g. within a few centimeters of the transmitters 110, 210, which may indicate a breach of the perimeter 120, 220;
Near: e.g. within a couple of meters of the transmitters 110, 210, which may indicate an approach to the perimeter 120, 220;
Far: e.g. greater than 10 meters away, which may indicate a perimeter in the vicinity.

However, the ranges are configured for the individual perimeter 120, 220.

The management platform also comprises a user module adapted to create and store individual user profiles.

Each user profile comprises a personal identifier, personal data regarding the user, user permissions and a user location history. The user permissions are set for each perimeter profile.

The user module is configured to receive proximity location data from the perimeter profile module and store it in a location history for the user.

The mobile application comprises: (1) detection protocol to identify broadcasted UUIs for transmitters 110, 120; (2) a data transmission protocol; (3) a data receiving protocol; (4) a mobile user interface to display/execute received data; and (5) one or more perimeter profiles (as discussed above). This allows the mobile application to function even in a situation where the mobile device has no signal/internet connection with the management platform.

The mobile application is configured to: (1) store a user's personal identifier; (2) sweep for and identify broadcasted UUIs for transmitters 110, 120; (3) transmit the transmitter UUIs and distance therefrom to the perimeter module of the server; and (4) receive and display/execute alerts received from the perimeter module.

Any smart mobile device with Bluetooth® technology and internet connectivity can be used with the system 100, 200, although Bluetooth® LE technology is preferred.

The transmitters 110, 210 are configured to be deployed around stationary and mobile target entities, by simple fixing or adhesion means, depending upon the material characteristics of the entity.

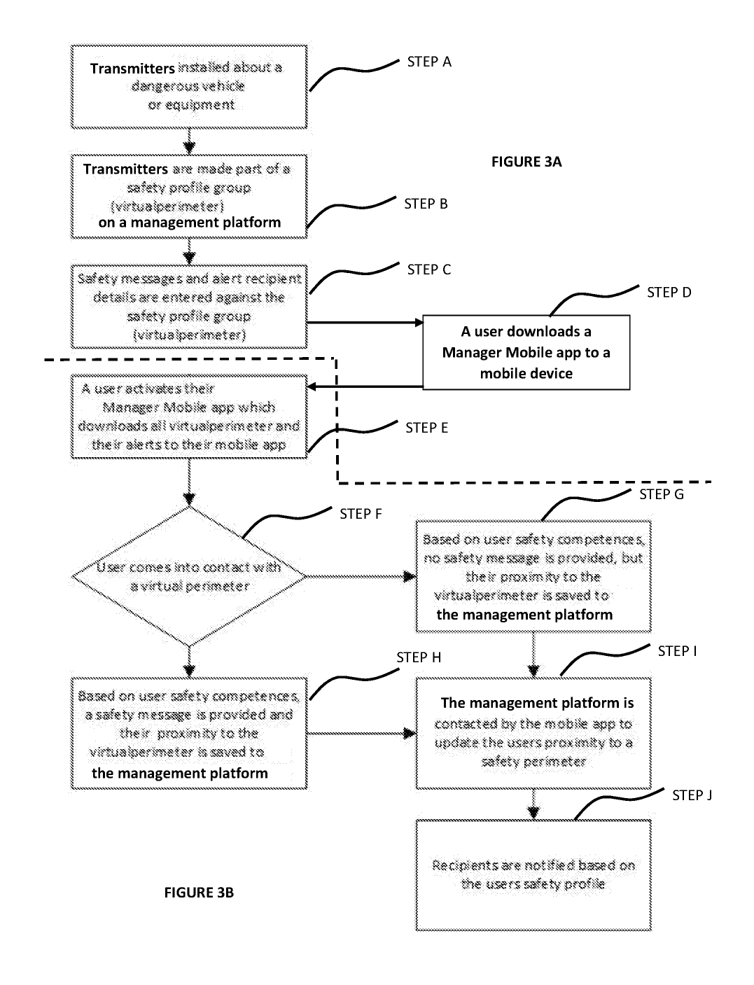

The method of set-up of the system 100, 200 is shown in FIG. 3A. Transmitters 110, 210 are located around a target entity 140, 240, by either attaching the transmitters 110, 210 directly to the entity 140, 240, or otherwise disposing them around the entity 140, 240 (STEP A). On the management platform, identification data and respective UUIs of each of the transmitters 110, 210 employed as part of a specific perimeter 120, 220 is stored as part of a particular profile, for example ‘Substation’ 100 or ‘Hazardous Waste Train’ 200 (STEP B). As part of each profile, the system is configured with one or more specific alert messages and/or alert procedures that are triggered when certain conditions are met (STEP C).

An individual user profile is also recorded on the management platform with a personal identifier and particular permissions set against the user relating to one or more perimeter profiles. For example, an ‘authorised’ user's profile (e.g. allowed within a perimeter 120, 220), may be configured to trigger a first warning alert message on an approach, but not an alert procedure on passing into the perimeter 120, 220, compared with an ‘unauthorised’ user's profile (e.g. not allowed within a perimeter 120, 220), which may be configured to trigger warning alert messages and an alert procedure.

Each user will require the installation of the mobile application to their respective mobile device 150, 250 configured to transmit the user's personal identifier (STEP D). The installation comprises the download of data relating to one or more perimeter profiles. This allows the mobile application to function even in a situation where the mobile device has no signal/internet connection with the management platform.

The method of use is shown in FIG. 3B. In use, when activated, the transmitters 110, 210 broadcast a UUI outwardly of their location within a predetermined range of say 10 metres. A user activates the mobile application on their mobile device 150, 250 (STEP E).

As a user approaches a wireless perimeter 120, 220 (STEP F), the mobile application on their mobile device 150, 250 picks up the UUIs of one or more of the transmitters 110, 210. The mobile application transmits data to the management platform with a user's personal identifier, the UUIs of the identified transmitters 110, 210 and in some instances, an approximate distance of the mobile device 150, 250 from the transmitters 110, 210.

Upon the data reaching the management platform, the server looks up the UUIs to determine the relevant wireless perimeter 120, 220 profile. Based upon range data transmitted by the application, the server is also able to determine the proximate location of the mobile device 150, 250 and therefore, the proximate location of the user, to the perimeter 120, 220. The server cross-references the wireless profile with the user's profile. The server saves the proximate location of the user against the user profile and depending upon the permissions for the user, the system may, or may not transmit an alert to the mobile device 150 (STEPS G and H).

In this respect, the user can be informed of the presence of a hazardous entity, the correct safety procedure (e.g. safety clothing) for an entity, or warned that they do not have the authorisation to enter that area.

The mobile application will continue to transmit updated proximity location data for a user to the management platform for recording in the user's profile.

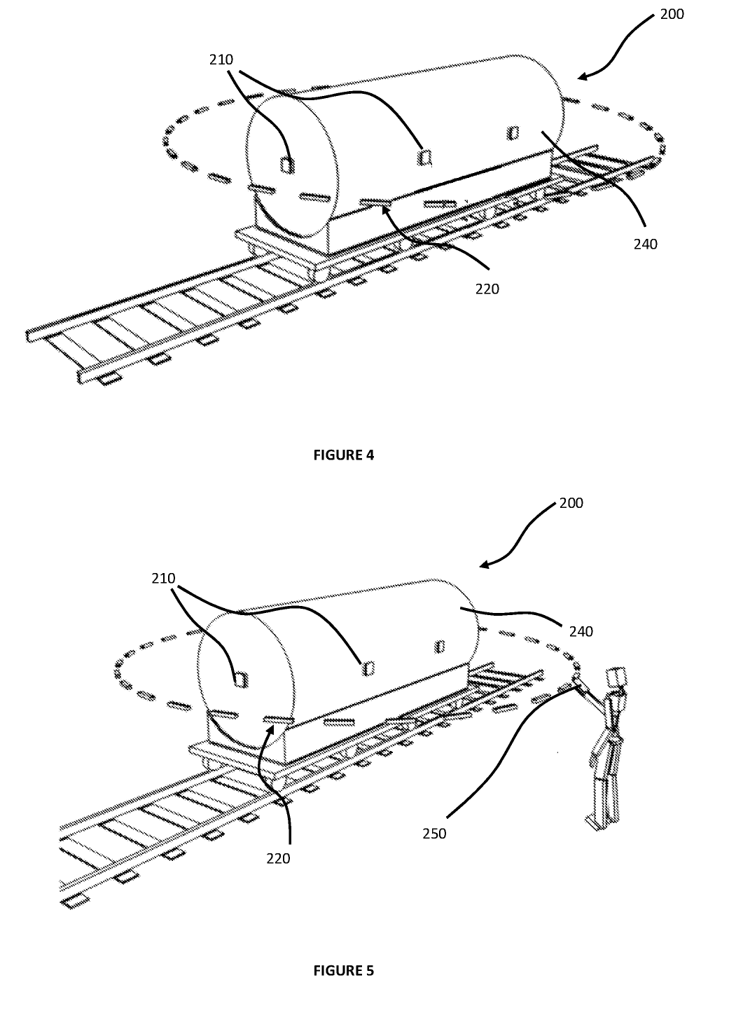

This system 100, 200 provides an efficient and inexpensive method of policing a dangerous area or vehicle, using transmitters 110, 220 broadcasting a universally unique identifier (UUI). The system 100, 200 takes advantage of the multi-functionality of today's mobile devices 150, 250 that are often provided/carried by to users for other communications means. The system only requires internet connectivity for the mobile device 150, 250 (which is standard) and the management platform. Furthermore, since the system 100, 200 depends upon a proximate mobile device 150, 250 for detection of the transmitter 110, 220 broadcast, the transmitters 110, 220 can be located on or around a stationary target entity, such as an electricity substation 140 (FIGS. 1 and 2), or can be attached to a mobile target entity, such as a vehicle or train carriage 240 (FIGS. 3 and 4).

Although a few preferred embodiments have been shown and described, it will be appreciated by those skilled in the art that various changes and modifications might be made without departing from the scope of the invention, as defined in the appended claims.

1. A virtual perimeter system for determining a position of a mobile device relative to a virtual perimeter, comprising:
a plurality of transmitters each configured to broadcast a unique identifier;
a management platform for storing positional data for each transmitter; and
a mobile application for installation on a mobile device,
the management platform being configured to communicate with the mobile application, the plurality of transmitters being positioned so as to define the virtual perimeter around a target entity, and the management platform is configured to:
(a) map the perimeter defined by said transmitters dependent upon the positional data stored;
(b) receive transmitted data from the mobile application when the mobile application detects the unique identifier of one or more of the transmitters and thereby determine a proximate location of the mobile device relative to the perimeter; and
(c) send an alert to the mobile application for display on said mobile device depending upon said proximate location,
the perimeter comprising a perimeter profile stored on the management platform comprising target entity information, and the target entity information comprises a mobility status of the entity,
wherein the transmitted data comprises a unique user personal identifier and the management platform comprises individual user profiles for each user in a user module comprising one or more of said user profiles, wherein each user profile comprises the user personal identifier and user permissions for the respective user,
the perimeter module being configured to receive the transmitted data from the mobile application and the perimeter module being configured to identify a respective user and store the proximity location within the user's profile in said user module,
the perimeter module further being configured to select an appropriate alert to said mobile application by cross-referencing the alerts in the perimeter profile with the user's permissions in the user profile.

2. The system according to claim 1, wherein the transmitters comprise wireless technology configured to exchange data over short distances.

3. The system according to claim 1, wherein the unique identifiers comprise universally unique identifiers (UUI), e.g. an identifier that is unique amongst all transmitters used worldwide.

4. The system according to claim 1, wherein the positional data comprises a transmitter position within the perimeter.

5. The system according to claim 3, wherein the perimeter profile comprises the UUI and the positional data for each transmitter.

6. The system according to claim 1, wherein the management platform comprises at least one perimeter profile.

7. The system according to claim 6, wherein each perimeter profile comprises a perimeter identifier.

8. The system according to claim 6, wherein each perimeter profile comprises: one or more alert messages and/or one or more alert procedures and/or one or more alert conditions.

9. The system according to claim 6, wherein the management platform comprises a perimeter module comprising one or more of said perimeter profiles.

10. The system according to claim 1, wherein the proximate location of the mobile device is determined using said transmitted data.

11. The system according to claim 3, wherein the transmitted data comprises at least the UUI of at least one transmitter.

12. The system according to claim 1, wherein the transmitted data comprises an approximate distance of the mobile device from at least one transmitter.

13. The system according to claim 1, wherein each user profile comprises a user location history for the respective user.

14. The system according to claim 1, wherein the user module is configured to receive proximity location data from the perimeter profile module and store it in the location history for the user.

15. The system according to claim 1, wherein the management platform is configured to receive transmitted data and transmit alerts over the internet to and from the mobile application.

16. The system according to claim 9, wherein the perimeter module is configured to identify respective perimeter profile by cross-referencing the received UUIs with the stored UUIs of each perimeter profile.

17. The system according to claim 1, wherein the mobile application is configured to approximately find its relative location to at least one transmitter.
